(19) United States
(12) Patent Application Publication
(10) Pub. No.: US 2008/0297484 A1
(43) Pub. Date: Dec. 4, 2008

(54) METHOD AND APPARATUS FOR PROVIDING GESTURE INFORMATION BASED ON TOUCHSCREEN AND INFORMATION TERMINAL DEVICE HAVING THE APPARATUS

(75) Inventors: Bo-eun PARK, Seongnam-si (KR); Jong-sung Joo, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/946,245

(22) Filed: Nov. 28, 2007

(30) Foreign Application Priority Data
May 29, 2007 (KR) 2007-52224

(51) Int. Cl. G06F 3/041

(52) U.S. Cl. 345/173

(57) ABSTRACT

A method and apparatus for enabling user interface (UI) interaction between an information terminal device and a user based on a touchscreen, and an information terminal device incorporating the apparatus. The method includes displaying an operation image on the touchscreen in accordance with an operation mode; sensing whether the touchscreen is touched on the displayed operation image; and displaying guide information having a predetermined form corresponding to the operation mode in order to enable a user interface (UI) interaction, if the touch of the touchscreen is sensed.

### CROSS-REFERENCE TO RELATED APPLICATIONS

This application claims the benefit of Korean Patent Application No. 2007-52224, filed in the Korean Intellectual Property Office on May 29, 2007, the disclosure of which is incorporated herein by reference.

### BACKGROUND OF THE INVENTION

1. Field of the Invention

Aspects of the present invention relate to a touchscreen based user interface (UI) method, and, more particularly, to a UI interaction method and apparatus for providing gesture information on a touchscreen of a multimedia terminal device.

2. Description of the Related Art

Multicontent players having touchscreens, such as personal computers (PCs), personal digital assistants (PDAs), portable multimedia players (PMPs), and MPEG Audio Layer III (MP3) players, have become widely popular. A multicontent player provides a variety of content to a user, including images and audio signals. The user operates the multicontent player by touching the touchscreen directly with a finger or a stylus pen, instead of, or in addition to, a standard keyboard or mouse. By using touch gestures, a plurality of functions, such as reproduction, stop, pause, fast forward, volume up, volume down, file transference, enlargement, reduction, file navigation, and image rotation, may be performed. For example, the user may move to a previous/next file by dragging a finger to the left or right of the touchscreen. Similarly, the user may enlarge or reduce content by dragging a finger to the top, bottom, left, or right of the touchscreen.

FIGS. 1A and 1B are views illustrating an example of a conventional method of operating functions on a touchscreen. As shown in FIG. 1A, the user may drag a display region of a previous/next album displayed on the touchscreen to the top/bottom or left/right of the touchscreen in order to enlarge or reduce a photographic image. As shown in FIG. 1B, if the user drags a photographic image, the photographic image enlarged by the dragging is displayed on the touchscreen.

However, the user cannot learn touch gestures for file manipulation directly from a conventional touchscreen based multicontent player. Accordingly, the user has to recognize the touch gestures from an instruction manual or related marketing information of the touchscreen based multicontent player. Furthermore, the conventional touchscreen based multicontent player may not provide a plurality of touch gestures for performing multiple tasks on a screen.

### SUMMARY OF THE INVENTION

Aspects of the present invention provide a method and apparatus to provide gesture information based on a touchscreen that allows a user to conveniently operate functions of an information terminal device by providing a guide image for interaction between the user and the information terminal device on a touchscreen of the information terminal device.

Aspects of the present invention also provide an information terminal device in which the method of providing gesture information based on a touchscreen is performed.

According to an aspect of the present invention, a method of providing gesture information based on a touchscreen is provided. The method includes displaying an operation image on the touchscreen in accordance with an operation mode; sensing whether the touchscreen is touched on the displayed operation image; and, displaying guide information having a predetermined form corresponding to the operation mode in order to enable a user interface (UI) interaction while the touch of the touchscreen is sensed.

According to another aspect of the present invention, an information terminal apparatus is provided. The information terminal apparatus includes a touchscreen to display an image and to display an operation image that corresponds to an operation mode and guide information having a predetermined form, in accordance with a touch due to a user's manipulation of the touchscreen; a memory unit to store content and guide information corresponding to a plurality of operation modes; and a control unit to display the guide information at a touch position of the touchscreen unit in order while the touchscreen is manipulated to enable a user interface (UI) interaction, and to perform a function in accordance with manipulation of the displayed guide information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B are views illustrating an example of a conventional method of operating functions on a touchscreen;

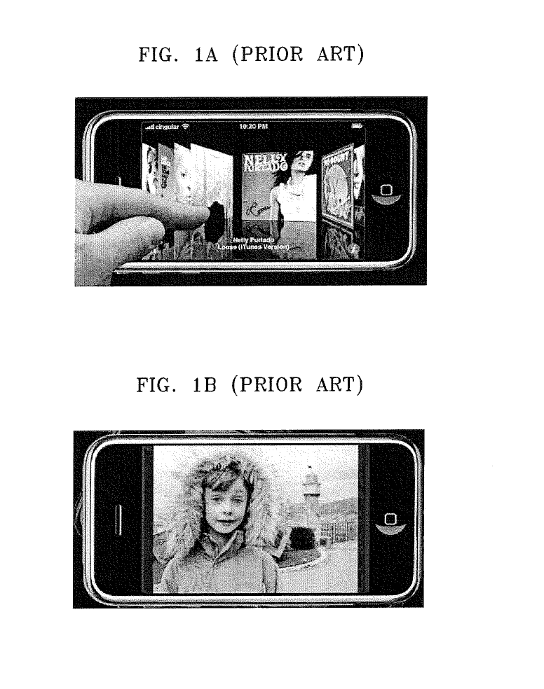

FIG. 2 is a schematic block diagram of an information terminal device to provide gesture information on a touchscreen, according to an embodiment of the present invention;

FIG. 3 is a flowchart of a method of providing gesture information of a touchscreen, according to an embodiment of the present invention;

FIGS. 4A through 4D are photographic images illustrating an example of performing a gesture function in a photo reproduction mode on a touchscreen, according to an embodiment of the present invention;

FIGS. 5A through 5D are photographic images illustrating an example of performing a gesture function in a music reproduction mode on a touchscreen, according to an embodiment of the present invention; and

FIGS. 6A through 6D are photographic images illustrating an example of performing a gesture function in a music-list view mode on a touchscreen, according to an embodiment of the present invention;

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

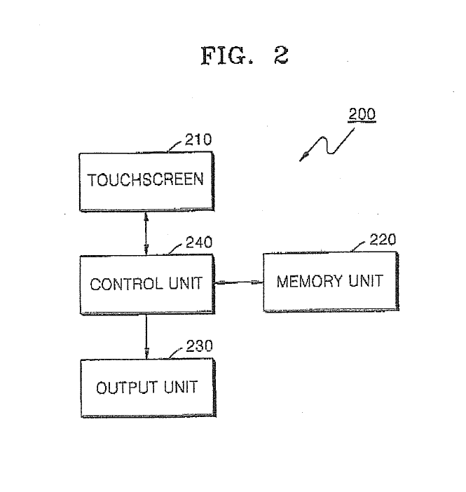

FIG. 2 is a schematic block diagram of a multimedia device (multicontent device) 200 to provide gesture information on a touchscreen, according to an embodiment of the present invention. The multimedia device includes a touchscreen unit 210, a memory unit 220, an output unit 230, and a control unit 240. According to other aspects of the invention, the multimedia device 200 may include additional or different units. Similarly, the functionality of two or more of the above units may be combined into a single component. The multimedia device 200 may be any computing apparatus or multicontent device, such as a mobile phone, a personal computer, a laptop computer, a personal digital assistant, or a personal entertainment device. Personal entertainment devices include video game players, video players, or music players.

The touchscreen unit 210 displays an image, senses touch or dragging by a user's manipulation using, for example, a sensor that reacts to pressure applied to a surface of a touchscreen, and displays an operation image in accordance with an operation mode and predetermined forms of guide information. The touchscreen 210 may sense touch using any method, such as a pressure method or a capacitance method.

The memory unit 220 stores screen information and the predetermined forms of guide information that correspond to a plurality of operation modes as well as multimedia content. According to aspects of the present invention, the guide information may be stored as paths, images, text, icons, or buttons corresponding to the operation modes. The output unit 230 reproduces the multimedia content as video/audio (AV) signals using a screen and/or a speaker.

The control unit 240 recognizes instructions resulting from manipulation of the touchscreen unit 210, controls the reproduction of the multimedia content, and displays or reproduces the multimedia content stored in the memory unit 220 by the touchscreen 210 or the output unit 230. The control unit 240 displays the operation image on the touchscreen 210, displays the guide information mapped to the operation modes and stored in the memory unit 220 if a touch is sensed on the displayed operation image, senses touch or dragging on the guide information displayed on the touchscreen 210, and performs a function corresponding to the touch or dragging. For example, the function may be volume up/down, or enlargement/reduction. The control unit 240 also converts a touch position to coordinate information.

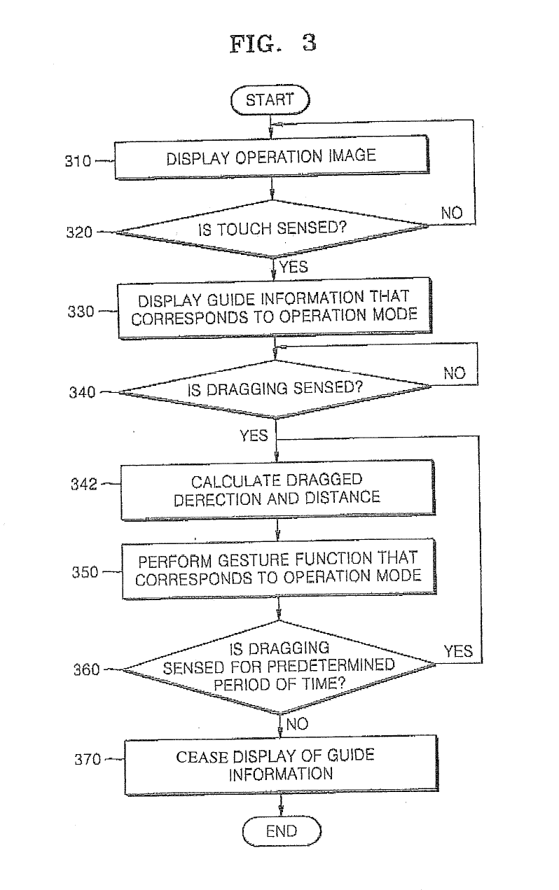

FIG. 3 is a flowchart of a process of providing gesture information of a touchscreen, according to an embodiment of the present invention. In operation 310, an operation image selected by a user is displayed on a touchscreen. The operation mode may be, for example, a photo reproduction mode, a music reproduction mode, an MPEG Audio Layer III (MP3) file reproduction mode, a telephone mode, a game mode, a video reproduction mode, or a recording mode. Operation images are previously stored in memory and may be mapped to corresponding operation modes.

When an object, such as a stylus pen or one or more fingers, touches a certain region of the touchscreen 210, the touch of the object is sensed in operation 320. A touch sensor may be employed to sense the touch of the object. X and y coordinates of the touch are calculated and guide information having a predetermined form is displayed in order to enable a UI interaction at a touch position on the touchscreen 210 in operation 330. The guide information may be displayed so as to overlap the operation image. The guide information may be displayed as one or more different graphics in accordance with a current operation mode.

According to an embodiment of the present invention, the guide information may be directly displayed as directional paths at the touch position. According to another embodiment, the guide information may be directly displayed as images, text, or icons corresponding to functions of the operation modes. According to still another embodiment, the guide information may be displayed as button graphics. For example, in an audio/video (AV) data reproduction mode, up/down paths may be displayed on the touchscreen 210 in order to control audio volume and left/right paths may be displayed on the touchscreen 210 in order to perform fast forward and rewind. The guide information may also be mapped to the operation modes, and the guide information to be displayed may vary depending on the current operation mode. According to another embodiment of the present invention, a touch sensor unit may be displayed separately from a main image at a predetermined region of the touchscreen 210 so as to display the guide information whenever the touch sensor unit is touched.

Manipulation of the touchscreen 210 by the user on the guide information displayed on the touchscreen 210 is sensed in operation 340. Manipulating the touchscreen 210 includes touching the touchscreen 210 with one or more fingers (or other object, such as a stylus) and/or moving (dragging) one or more fingers (or other object) across the touchscreen 210. For example, the user may touch two (or more) places on the touchscreen 210 corresponding to the displayed guide information simultaneously. Similarly, the user may drag a finger across the touchscreen 210 in a direction indicated (or suggested) by the guide information. Other motions are possible as well, such as “pinching” (touching two fingers to the touchscreen 210 at different places and moving the fingers together) or “expanding” (touching two fingers to the touchscreen 210 and moving the fingers apart.)

The sensing of the touch may be performed using any method, such as a motion coordinate method. If the dragging is sensed from the touch position, dragged direction and distance are calculated in operation 342. According to another embodiment of the present invention, if the pressure of the button is sensed, the amount of time pressure is applied to the button (hereinafter, referred to as pressure time) is calculated.

A gesture function corresponding to the dragged direction and distance or to the pressure time is performed in operation 350. For example, in the photo reproduction mode, when the guide information displayed at the touched position is dragged up or down, a corresponding portion of a photographic image may be enlarged or reduced in accordance with the dragged direction and distance. In the AV data reproduction mode, the audio volume may be controlled in accordance with the dragged distance on the up/down paths, and fast forward and rewind may be controlled in accordance with the dragged distance on the left/right paths. According to another embodiment of the present invention, by using the guide information formed as button graphics corresponding to the operation modes and displayed on the touchscreen 210, a function may be performed whenever a corresponding button graphic is touched.

Whether the dragging by the user is sensed on the guide information displayed on the touchscreen 210 is checked for a predetermined period of time in operation 360. If the dragging is sensed for the predetermined period of time, a corresponding gesture function is performed in accordance with the operation mode. However, if the dragging is not sensed for the predetermined period of time, then in operation 370 the guide information is no longer displayed.

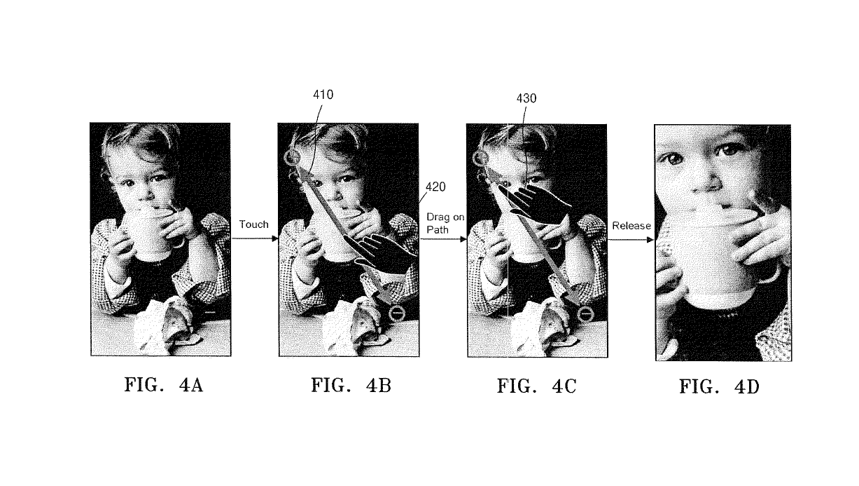

FIGS. 4A through 4D are photographic images illustrating an example of performing a gesture function in a photo reproduction mode on the touchscreen 210, according to an embodiment of the present invention. As shown in FIG. 4A, if the photo reproduction mode is operated, a photo reproduction image is displayed on the touchscreen 210. If a user 420 touches a certain position on the photo reproduction image, guide information 410 having up/down paths is overlaid and displayed on the photo reproduction image, as shown in FIG. 4B. The user 420 drags a finger (or other object) along the guide information so as to enlarge the photo reproduction image, as shown in FIG. 4C. As shown in FIG. 4D, if the dragging is not performed for a predetermined period of time after the photo reproduction image is enlarged, display of the guide information 410 ceases (the guide information is no longer displayed.) A similar process may be used in other modes as well, such as a selection mode to select items from a list.

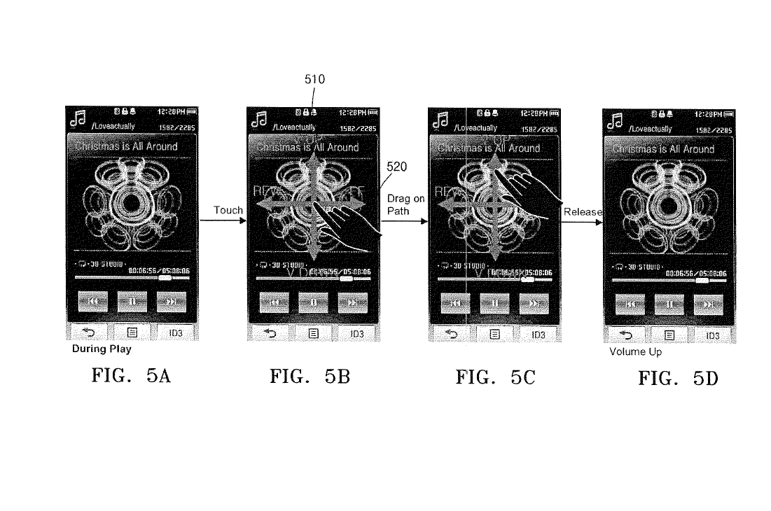

FIGS. 5A through 5D are photographic images illustrating an example of performing a gesture function in a music reproduction mode on the touchscreen 210, according to an embodiment of the present invention. As shown in FIG. 5A, if the music reproduction mode is operated, a previously-set music reproduction image is displayed on the touchscreen 210. If a user 520 touches a certain position on the music reproduction image, guide information 510 having up/down/left/right paths is overlaid on the music reproduction image, as shown in FIG. 5B. As shown in FIG. 5C, if the user 520 drags the guide information 510 up/down, volume up/down is performed, and if the user 520 drags the guide information 510 left/right, rewind/fast forward is performed. If the dragging is not sensed for a predetermined period of time after the volume up/down or the rewind/fast forward is performed, display of the guide information 510 ceases, as shown in FIG. 5D.

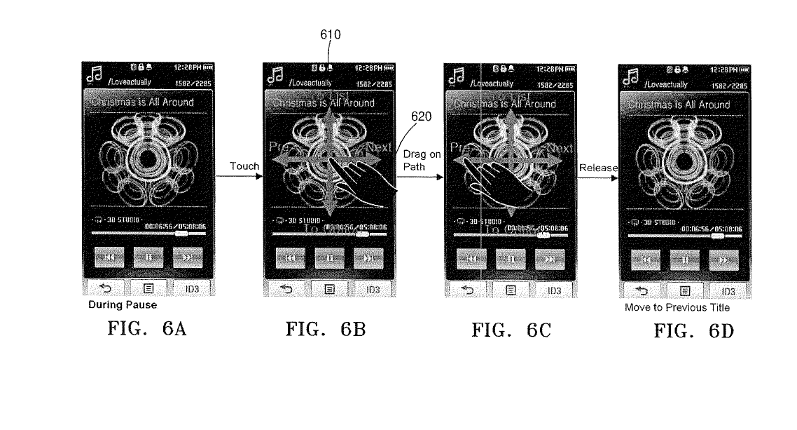

FIGS. 6A through 6D are photographic images illustrating an example of performing a gesture function in a music-list view mode on the touchscreen 210, according to an embodiment of the present invention. As shown in FIG. 6A, if the music-list view mode is operated, a music-list view image is displayed on the touchscreen 210. If a user 620 touches a certain position on the music-list view image, guide information 610 having up/down/left/right paths is overlaid on the music-list view image, as shown in FIG. 6B. As shown in FIG. 6C, if the user 620 drags the guide information 610 up/down, music-list view/option setting is performed, and if the user 620 drags the guide information 610 left/right, previous/next file view is performed. As shown in FIG. 6D, if the dragging is not sensed for a predetermined period of time after the music-list view/option setting or the previous/next file view is performed, display of the guide information 610 ceases.

Aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CDs and DVDs; magneto-optical media such as optical disks; and hardware devices that are specially configured to store and perform program instructions, such as read-only memory (ROM), random access memory (RAM), flash memory, and the like; and a computer data signal embodied in a carrier wave comprising a compression source code segment and an encryption source code segment (such as data transmission through the Internet). The computer readable recording medium can also be distributed over network coupled computer systems so that the computer readable code is stored and executed in a distributed fashion. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

As described above, according to aspects of the present invention, by providing guide information for UI interaction on a touchscreen of a multimedia device, a user may conveniently operate functions of the information terminal device. The user may also directly use touch gestures for tasks on the touchscreen instead of learning the touch gestures from an instruction manual or the like. Furthermore, the multimedia device may provide a plurality of touch gestures on the touchscreen at the same time. Accordingly, the multimedia device may display guide information having a plurality of paths on the touchscreen and may induce the user to operate the functions correctly in accordance with the guide information.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of providing gesture information based on a touchscreen, the method comprising:
displaying an operation image on the touchscreen in accordance with an operation mode;
sensing whether the touchscreen is touched on the displayed operation image; and
displaying guide information having a predetermined form corresponding to the operation mode in order to enable a user interface (UI) interaction while the touch of the touchscreen is sensed.

2. The method of claim 1, wherein the displaying of the guide information comprises overlaying the guide information determined in accordance with the operation mode at a touched position of the touchscreen.

3. The method of claim 1, wherein the displaying of the guide information comprises displaying directional paths at a touched position of the touchscreen.

4. The method of claim 1, wherein the displaying of the guide information comprises displaying graffiti or images at a touched position of the touchscreen.

5. The method of claim 1, wherein the displaying of the guide information comprises displaying buttons at a touched position of the touchscreen.

6. The method of claim 1, wherein the displaying of the guide information comprises displaying different guide information for different operation modes.

7. The method of claim 1, wherein the displaying of the guide information comprises displaying a plurality of guide information to perform a plurality of functions in accordance with the operation mode.

8. The method of claim 1, wherein a plurality of guide information is mapped to corresponding operation modes.

9. A method of controlling a touchscreen based information terminal device, the method comprising:
displaying an operation image on the touchscreen in accordance with an operation mode;
sensing whether the touchscreen is touched on the displayed operation image;
displaying guide information having a predetermined form corresponding to the operation mode in order to enable a user interface (UI) interaction while the touch of the touchscreen is sensed; and
performing a function corresponding to the operation mode by manipulating the displayed guide information.

10. The method of claim 9, wherein the performing of the function corresponding to the operation mode comprises:
sensing a dragging of an object across the touchscreen in accordance with the displayed guide information;
performing a function that corresponds to a dragged distance if the dragging is sensed; and
ceasing the displaying of the guide information if the dragging is not sensed for a predetermined period of time.

11. An information terminal apparatus comprising:
a touchscreen to display an image and to display an operation image that corresponds to an operation mode and guide information having a predetermined form, in accordance with a touch due to a user's manipulation of the touchscreen;
a memory unit to store content and guide information corresponding to a plurality of operation modes; and
a control unit to display the guide information at a touch position of the touchscreen unit while the touchscreen is manipulated in order to enable a user interface (UI) interaction, and to perform a function in accordance with manipulation of the displayed guide information.

12. A computer readable recording medium having recorded thereon a computer program to execute a method of providing gesture information of a touchscreen, the method comprising:
displaying an operation image on the touchscreen in accordance with an operation mode;
sensing whether the touchscreen is touched on the displayed operation image;
displaying guide information having a predetermined form corresponding to the operation mode in order to enable a user interface (UI) interaction while the touch of the touchscreen is sensed; and
performing a function corresponding to the operation mode by manipulating the displayed guide information.

13. The apparatus of claim 11, wherein the control unit senses the manipulation of the touchscreen, and displays the guide information and performs the function based on the manipulation of the touchscreen.

14. The apparatus of claim 11, wherein the controller displays the guide information at a touched position of the touchscreen.

15. The apparatus of claim 14, wherein the guide information comprises directional paths.

16. The apparatus of claim 14, wherein the guide information comprises images or icons.

17. The apparatus of claim 14, wherein the guide information comprises buttons.

18. The apparatus of claim 11, wherein the controller displays different guide information corresponding to a current operation mode of the information terminal apparatus.

19. A method of aiding a user in manipulating a touchscreen so as to perform functions of a multimedia apparatus, the method comprising:
displaying an operation image on a touchscreen of the multimedia apparatus corresponding to a current operation mode;
displaying guide information corresponding to the current operation mode while the touchscreen is manipulated; and
performing a function of the current operation mode based on a manipulation of the touchscreen in response to the displaying of the guide information.

20. The method of claim 19, wherein the current operation mode is one of a plurality of operation modes, and each operation mode corresponds to one of a plurality of guide information.

21. The method of claim 19, wherein the displaying of the guide information comprises displaying the guide information over the operation image.

22. The method of claim 19, wherein the current operation mode is a photo reproduction mode, the guide information comprises a straight line, and the performing of the function comprises zooming in or zooming out based on the manipulation of the touchscreen.

23. The method of claim 19, wherein the current operation mode is a music reproduction mode, the guide information comprises horizontal and vertical lines, and the performing of the function comprises adjusting the volume, rewinding, or fast forwarding based on the manipulation of the touchscreen.

24. The method of claim 19, wherein the current operation mode is a music-list view mode, the guide information comprises horizontal and vertical lines, and the performing of the function comprises selecting a new song or viewing a list of songs based on the manipulation of the touchscreen.

25. The method of claim 19, further comprising:
ceasing the displaying of the guide information when the manipulation of the touchscreen ceases.
